(19) United States
(12) Patent Application Publication
(10) Pub. No.: US 2024/0027278 A1
(43) Pub. Date: Jan. 25, 2024

(54) ARTIFICIAL ENVIRONMENT MONITORING

(71) Applicant: BLUSTREAM CORPORATION, Worcester, MA (US)

(72) Inventors: Michael Dominick Audi, Worcester, MA (US); William Buote, Worcester, MA (US); Kenneth N. Rapp, Sutton, MA (US); Robert Bean, Worcester, MA (US); James Michael Gordon, Jr., Worcester, MA (US)

(21) Appl. No.: 18/040,733

(22) PCT Filed: Aug. 6, 2021
(86) PCT No.: PCT/US2021/045109

§ 371 Date: Feb. 6, 2023

Related U.S. Application Data
(60) Provisional application No. 63/062,748, filed on Aug. 7, 2020.

(51) Int. Cl. G01K 1/02; G01K 1/14; G01K 3/02; H05B 47/11; A01K 63/06

(52) U.S. Cl. CPC G01K 1/026; G01K 1/14; G01K 3/02; H05B 47/11; A01K 63/065; G01K 2213/00

(57) ABSTRACT

A monitoring system can implement a method including receiving data characterizing first measurements recorded by a sensor in a heating area, second measurements recorded by the sensor in an ambient area, and third measurements recorded by the sensor in a central area, located between the heating area and the ambient area. The method further includes determining a first average temperature, a second average temperature, and a third average temperature. The method further includes computing a first temperature difference between the first average temperature in the heating area and the third average temperature in the central area, and a second temperature difference between second average temperature in the ambient area and the third average temperature of the central area. The method further includes providing the first temperature difference and the second temperature difference.

### RELATED APPLICATION

This application claims priority under 35 U.S.C. § 119(e) to U.S. Provisional Patent Application No. 63/062,748 filed on Aug. 7, 2020, the entire contents of which is hereby expressly incorporated by reference herein.

### TECHNICAL FIELD

The subject matter described herein relates to monitoring and management of artificial environments.

### BACKGROUND

Artificial environments can require certain inputs in order to keep the environment stable. Sensors are an integral part of determining the factors which influence the artificial environment. A sensor can detect physical properties such as motion, temperature, position, and the like, and generate a signal that represents the detected physical property. The generated signal can be processed and stored by a computing device. The computing device can control the operation of the sensor. For example, the computing device can control the operation of the sensor (e.g., change the operating parameters associated with the sensor).

Certain exotic reptiles can be kept in an artificial environment. Reptiles can be cold blooded and may need specific ranges of temperature values. Additionally, reptiles may need two temperature zones to regulate their body temperature (e.g., a heating area and an ambient or cooling area). A traditional monitoring system can include multiple temperature sensors distributed over the enclosure that can allow for accurate temperature detection of the heating area, the ambient area and the area between the basking and the ambient area. In addition to the multiple temperature sensors, the enclosure can also include type B ultraviolet (UVB) sensors to detect the UVB radiation in the enclosure. The UVB radiation can play an important role in the development of exoskeleton of the reptile, and therefore may need to be regulated (e.g., the UVB bulb may need to be replaced every 3 to 6 months). Additionally, the humidity of the enclosure may need to be regulated based on the reptile housed in the enclosure (e.g., humidity levels can be regulated to mimic the home climate of the reptile). In some implementations, hand operated analog or digital hygrometers can be used to manually check (e.g., daily) the humidity levels. These traditional systems require multiple sensors arranged about the enclosure in order to properly determine the humidity, temperature, and UV levels within the enclosure.

### SUMMARY

In an aspect, a method includes receiving data characterizing first parameter measurements recorded by a sensor in a heating area of an enclosure for a first duration of time, second parameter measurements recorded by the sensor in an ambient area of the enclosure for a second duration of time, and third parameter measurements recorded by the sensor in a central area, located between the heating area and the ambient area, for a third duration of time. The method further includes determining a first average parameter recorded during the first duration of time, a second average parameter recorded during the second duration of time, and a third average parameter recorded during the third duration of time. The method further includes computing a first temperature difference between the first average parameter in the heating area and the third average parameter in the central area, and a second parameter difference between second average parameter in the ambient area and the third average parameter of the central area. The method further includes providing the first parameter difference and the second parameter difference.

One or more of the following features can be included in any feasible combination. For example, the first parameter measurements, the second parameter measurements, and the third parameter measurements can be temperature measurements. In some aspects, the method can include receiving data characterizing fourth measurements recorded by the sensor in the central area for a fourth duration of time. The method can further include determining a fourth average temperature recorded during the fourth duration of time. The method can further include computing a calculated heating area temperature and a calculated ambient area temperature based on the first temperature difference, the second temperature difference and the fourth average temperature. The method can further include providing the calculated heating area temperature and the calculated ambient area temperature.

In some aspects, the fourth measurements can include a UV light level. In certain aspects, the UV light level can be a type B ultraviolet light level. In some aspects, the method can further include computing a day and/or night cycle based on the fourth average temperature. In certain aspects, the fourth measurements can include a humidity level.

In some aspects, the method can include receiving data characterizing UV light level measurements recorded by the sensor in the central area. In other aspects, the method can include computing a day and/or night cycle based on the recorded UV light level measurements. In certain aspects, the UV light level measurements can be type B ultraviolet light level measurements.

In an aspect, a method includes receiving a temperature data set, a humidity data set, and an ultraviolet light level data set, characterizing measurements of a plurality of characteristic properties of an artificial environment by a sensor operatively arranged within the artificial environment. The method can further include determining, by a predictive model, a first rule characterizing environmental requirements of an object in the artificial environment. The method can further include generating an output data set based on the received data sets and the first rule. The method can further include transmitting the generated output data set.

One or more of the following features can be included in any feasible combination. For example, the first rule can be based on information associated with the artificial environment provided by the user, previous measurements of the characteristic properties by the sensor, and the received data sets. In other aspects, the output data set can include information and/or instructions associated with care of the artificial environment. In some aspects, the output data set includes an object replenishment recommendation associated with a consumable object within the artificial environment. In other aspects, the output data set can include a control command associated with stabilization of the artificial environment. In certain aspects, the control command can be associated with the control at least one of a heating source, a humidifier, or a UV source.

In some aspects, the method can further include generating the output data set for the artificial environment can be further based on one or more of environmental data associated with the artificial environment, usage of the artificial environment, location of the artificial environment, and a type associated with the artificial environment.

In some aspects, the artificial environment monitoring system can further include an application on a computing device associated with the user of the artificial environment, and the receiving of the data sets by the server is via the application. In other aspects, the generated output data set can be transmitted to the computing device.

In an aspect, a system includes at least one data processor, and memory storing instructions which, when executed by the at least one data processor, causes the at least one data processor to perform operations including receiving a temperature data set, a humidity data set, and an ultraviolet light level data set, characterizing measurements of a plurality of characteristic properties of an artificial environment by a sensor operatively arranged within the artificial environment. The method can further include determining, by a predictive model, a first rule characterizing environmental requirements of an object in the artificial environment. The method can further include generating an output data set based on the received data sets and the first rule. The method can further include transmitting the generated output data set.

One or more of the following features can be included in any feasible combination. For example, the output data set can include at least one of information and/or instructions associated with care of the artificial environment, an object replenishment recommendation associated with a consumable object within the artificial environment, or a control command associated with stabilization of the artificial environment.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, and the like.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1 is a flow chart of an exemplary method for providing a recommendation to a target object by an object monitoring system;

FIG. 2 illustrates an exemplary object monitoring system configured to monitor multiple target objects;

FIG. 3 illustrates an exemplary server associated with the object monitoring system of FIG. 2;

FIG. 4 illustrates an exemplary recommendation engine associated with the server of FIG. 3;

FIG. 5 illustrates an exemplary rules engine associated with the server of FIG. 3;

FIG. 6 illustrates an exemplary data processing engine associated with the server of FIG. 3;

FIG. 7 illustrates an exemplary support engine associated with the server of FIG. 3;

FIG. 8 illustrates an exemplary graphical user interface (GUI) display space of an application associated with the object monitoring system of FIG. 2;

FIG. 9 illustrates an exemplary embodiment of an artificial environment; and

FIG. 10 illustrates exemplary graphs of a change of UVB intensity and visible light with time.

### DETAILED DESCRIPTION

Some implementations of the current subject matter can provide automated data outputs during a valuable product's lifecycle by analyzing data about the valuable product's environment, activities, and external information (e.g., time, weather, location, object properties, and the like). Further examples of data can include the end user's experience, preferences, collection, and the like. For example, if an individual has an artificial environment, such as an enclosure for a reptile, the output data set can include a suggestion for buying a consumable object, such as a UV light, or activating a dehumidifier/humidifier or heater.

Some implementations of the current subject matter can improve the communication characteristics (e.g., communication of recommendations) to ensure effective actions based upon supplier recommendations and end user actions over time. Some implementations of the current subject matter can provide systems and methods that can create opportunities for both the end users and the supplier to form an individual relationship where the end user is connected to the supplier for support while using the product throughout the life cycle of the product. This can allow the supplier to customize the relationship with each individual end user which can help to ensure end user's success with the product. End users can benefit from such a relationship by gaining better results and enjoyment from the products they use, while suppliers can benefit by gaining higher success rates, ratings, repeat sales and ongoing revenue from the products.

In some implementations, an application associated with a computing device of the end user can receive sensor data detected by sensors operatively coupled to the object. The sensor data can include, for example, temperature, humidity, motion, impact, location, sound level, vibration, and the like, associated with the object. This data can be combined with data sourced from outside references such as weather reports, event announcements, emergency incidents, and the like, and can be used by the system to independently assess the state of the object.

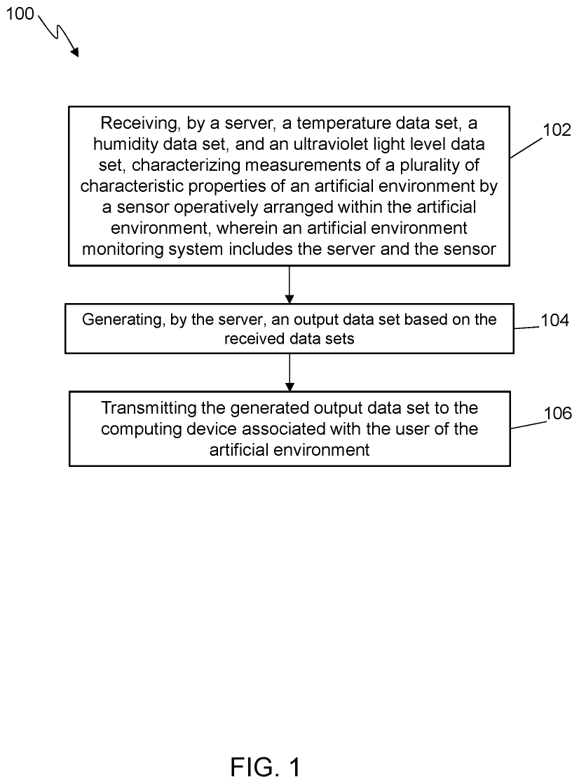

FIG. 1 is a flow chart of an exemplary method for providing an output data set to an artificial environment by an artificial environment monitoring system. At 102, data characterizing a plurality of measurements, such as temperature, humidity, and type B ultraviolet light (UVB) level, of a characteristic property of the artificial environment (e.g., which can be detected by a sensor operatively arranged within the artificial environment) is received. The data can be received, for example, by a platform (or a server) of the artificial environment monitoring system.

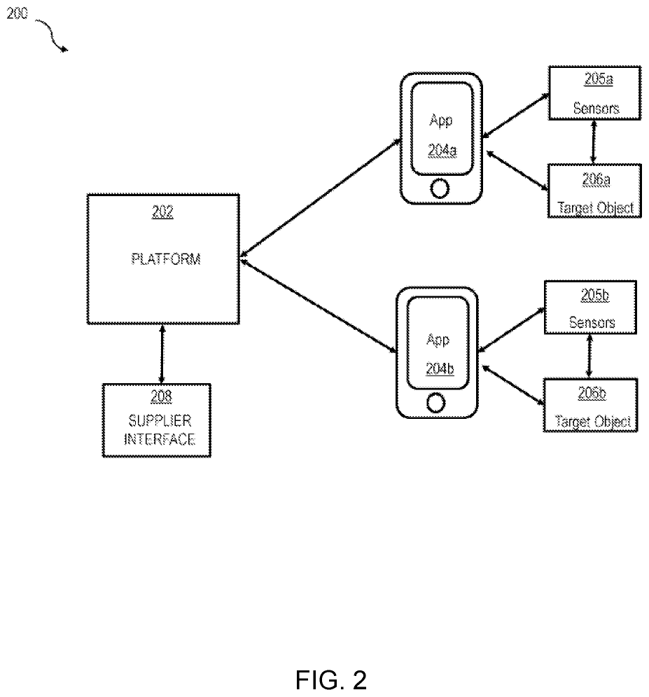

Various components of the artificial environment monitoring system can be distributed over a cloud, operating devices of users of multiple artificial environments, locations of the artificial environment (e.g., sensors arranged within artificial environments and the like). For example, FIG. 2 illustrates an exemplary artificial environment monitoring system 200 that includes a platform 202; applications 204a and 204b; sensors 205a and 205b; and a supplier interface 208.

The artificial environment monitoring system 200 can monitor and provide output data sets to the target objects 206a and 206b. The sensor 205a (or 205b) can detect a characteristic property of the target object 206a (or 206b) and transmit the detected characteristic property to the application 204a (or 204b). The application 204a (or 204b) can be installed on a computing device (e.g., laptop, mobile device, and the like) of the user of the target object 206a (or 206b). The application can curate the received sensor data and/or transmit the sensor data to the platform 202. In some implementations, the application can be used by end users to place new orders (e.g., replenishing consumable products), request object information, receive information or instructions to properly maintain the artificial environment, and the like.

The platform 202 can receive the data from the applications 204a (or 204b) (e.g., data characterizing a measurement of the characteristic property of the target object) and/or sensor data directly from the sensor 205a (or 205b). The supplier interface 208 can allow the supplier to access information in the artificial environment monitoring system 200 (e.g., information about the product/object, end users, and the like).

Communication among platform 202; applications 204a and 204b; and sensors 205a and 205b can be achieved via one or more of WiFi, Cellular Radio, Bluetooth, low data rate infrastructure, direct wiring, and the like. In some implementations, one or more relay stations can allow for communication among the components of the object monitoring system 200. In some implementations, the various components of the artificial environment monitoring system 200 can include data storage devices (e.g., memory, RAM, and the like) that can curate received/generated information.

Referring again to FIG. 1, at 104, the platform 202 generates an output data set for the target object 206a (or 206b) based on the received data. As described below, the generation of the recommendation can also be based on various data (e.g., result associated with the implementation of a previous recommendation on the target object 206a, sensor data from multiple target objects, expert data, and the like). Furthermore, the recommendation can be generated by application of various rules (e.g., predetermined rules, rules provided by experts, and the like) on the various data.

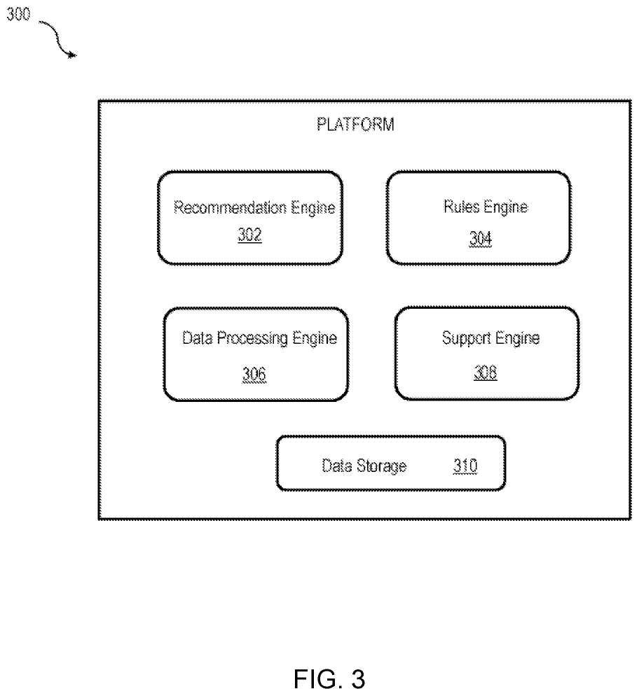

FIG. 3 illustrates an exemplary platform 300. The platform 300 can include a recommendation engine 302, rules engine 304, data processing engine 306, support engine 308 and data storage 310. The platform 300 can receive data from various sources (e.g., sensors operatively coupled to the objects, external database, experts, and the like). The recommendation engine 302 can generate recommendations based on, for example, received data, rules generated by the rules engine 304 (and/or rules from experts). The data processing engine can process the received data (or a portion thereof) and the support engine 308 can respond to queries from the end user.

The data storage 310 can store various information associated with the target objects. For example, data storage 310 can included the lifecycle information of the target object (e.g., stage of the object, milestone of the object, action level criteria, notifications associated with the object, and the like). The data storage 310 can also include information associated with the class or group associated with the target object. The group information can include, for example, summary notice content in target objects of the group, summary notice call to action in multiple target objects in the group, and the like.

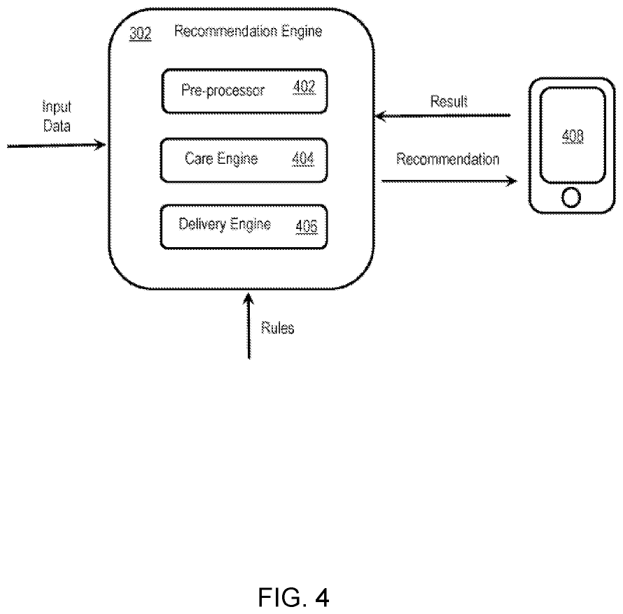

FIG. 4 illustrates an exemplary recommendation engine 302. The recommendation engine 302 can receive data from various sources (e.g., sensor data, rules from the rules engine, data from data storage 310, and the like) and can generate recommendation for the target object. In some implementations, the recommendation can instruct the end user to act to protect, preserve or better use the target object associated with the recommendation. The recommendation engine 302 can include a pre-processor engine 402, a care engine 404 and the delivery engine 406. The pre-processor engine 402 can process received data (e.g., sensor data, data from data storage 310, and the like). In some implementations, the processing of data can be done to prepare (or analyze) the data for execution by the care/delivery engines. For example, received data can be unstructured, or only a fraction of the data may be needed to produce an actionable insight by the care and delivery engines. The pre-processor engine 402 can select the desirable sub-set of data and/or prepare the data for usage by the care/delivery engines.

In some implementations, an algorithm or rule can analyze the received data and determine recommendation characteristics (e.g., whether the recommendation should be in a text form or a video form). This determination can be on historical user response to various recommendations (e.g., how often the user looked at the recommendation, how long the user spent engaging with the object monitoring system, how successful the resulting care actions were, etc.) to determine recommendation characteristics. In some implementations, recommendation characteristics can be transmitted to the delivery engine.

The care engine 404 can receive processed data from the pre-processor 402 and can generate recommendations. For example, the care engine 404 can apply rules (e.g., group rules, individual object rules, expert rules, and the like) received from the rules engine 304 and can apply those rules on the received data. Rules can be applied based on defined triggers. In some implementations, triggers can be time based, based on received data, an external event from a supplier's server, and the like. When a trigger fires, the care engine 404 can determine which rule or rules need to be executed. The execution of the rule may take place on the same server as the care engine or on a different server. The rule may or may not be provided all of the data with the trigger that is needed to execute the rule. If additional data is needed, the care engine 404 may try and get the data from a database, server, or other location. The care engine 404 can process the rule with the limited data, or may stop the execution of the rule.

For example, transmission from a sensor indicating that an artificial environment, such as a habitat for a reptile, has fallen outside of an allowable temperature threshold can trigger the rule engine to determine that a temperature which is too cold corresponds to Rule 1. Rule 1 can state that if the temperature of the artificial environment is below a certain threshold limit, the user should activate a heat lamp, or the heat lamp can be automatically turned on by a processor. Rule 1 may only have the data that the temperature has been below a threshold limit the last 4 hours, so it queries the data from a database to find out if the temperature has been consistently below the threshold limit for 12 hours or not. If the answer is negative, a recommendation can be sent to the owner, or a control command can be sent to activate a heat lamp. In some exemplary implementations, humidity level or UV light level can be measured and compared instead of temperature of the artificial environment.

In some implementations, the care engine 404 can determine an evaluation parameter for one or more registered target objects by applying the received rules on the received data. Based on the evaluation score, the recommendation engine can make a determination if a recommendation needs to be made. In some implementation, the recommendation can be determined (e.g., selected from a predetermined list of recommendations) based on the evaluation score. The recommendation can indicate, for example, if an operating state (or operating parameter) of the target object should be changed by the end user.

Referring again to FIG. 1, at 106, the generated recommendation (e.g., generated by the care engine 404) can be transmitted to the computing device (e.g., application 204a in the user computing device) associated with the first target object (e.g., 206). The delivery engine 406 can generate parameters associated with the communication (“communication parameters”) of the recommendations generated by the care engine 402. For example, the delivery engine 406 can determine the schedule for providing the recommendation to the user. In some implementations, the communication parameters can be based rules provide by a Digital Marketing Subject Matter Expert (DSME). In some implementations, the delivery engine 406 can determine additional information associated with the recommendation. For example, the delivery engine 406 can determine a schedule associated with the implementation of the recommendation (e.g., when the recommendation needs to be implemented, and the like).

In some implementations, the delivery engine 406 can include a transmission machine learning algorithm. The transmission machine learning algorithm can generate the communication parameters based on information associated with the target object (e.g., personalized information for a given target object or the user of the target object), sensor data from the target object, input from DSME, and the like. In some implementations, the DSME can review and edit the communication parameters.

In some implementations, the recommendation engine 302 can perform multiple iterations (e.g., based on new data, new rules, trigger inputs from the end user, trigger inputs based on predetermined condition, trigger inputs from experts and the like). In some implementations, an input from the PSME can trigger the recommendation engine 302 (e.g., to generate recommendation). The input from the PSME can include state/milestone of the target object, conditions/limiting values associated with the various states of the target object, and the like. The recommendation engine 302 can include one or more of a genetic algorithm, Bayesian network, rete algorithm, inference engine, predictive model, business rule, machine learning model, neural network, classification system (e.g., random forest), regression system (e.g., least squares), and the like. In some implementations, the PSME can instruct the recommendation engine 302 to perform a machine learning process (e.g., based on data in data storage 310).

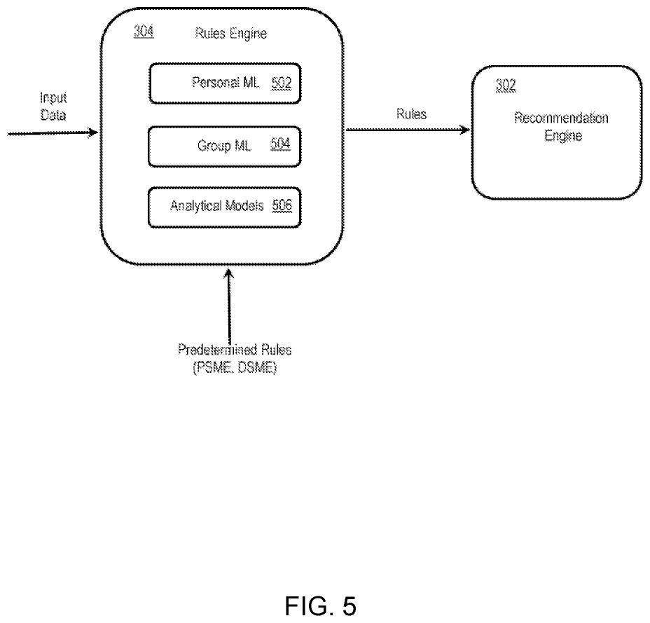

FIG. 5 illustrates an exemplary rules engine 304. The rules engine 304 can include a personal machine learning algorithm 502, a group machine learning algorithm 504 and analytical models 506. The personal machine learning algorithm 502 can generate a first set of object rules based on information associated with a given target object (e.g., personalized information for a given target object or the user of the target object) and/or macro trend information. The target object information can include one or more of data provided the by user of the target object, sensor data from the target object, data associated with a result from the implementation of a previous recommendation (e.g., from the platform 300 to the target object).

The group machine learning algorithm 504 can generate a second set of object rules based on information associated with a group (e.g., predefined group) associated with the target object. For example, the information can include macro trend information associated with the group of target objects. The target object information can include sensor measurements associated with a plurality of target objects in the group, group data from the data storage 310. In some implementations, the information can include personalized information.

In some implementations, generating the first (or second) set of rules can include using predetermined analytical models and varying the properties of the analytical models (e.g., predetermined constants in the analytical model) based on the above-mentioned personalized information (or macro trend information). In some implementations, the analytical models can include previously implemented rules. Based on new information (e.g., newly detected sensor data, new personalized information, new macro trend information, and the like), the previously implemented rules can be modified to generate new rules. In some implementations, the previously implemented first/second set of rules can be modified based on input rules provided by a PSME.

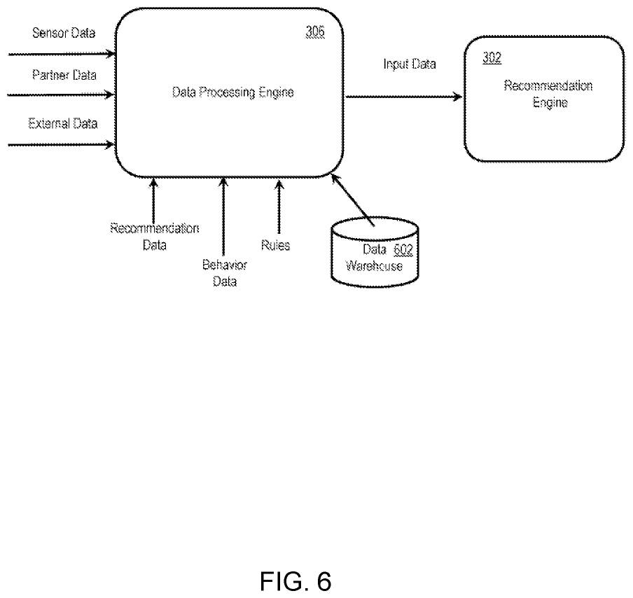

FIG. 6 illustrates an exemplary data processing engine 306. The data processing engine 306 can receive one or more of sensor data, recommendation data (e.g., data characterizing result of implementation of a recommendation), external data (e.g., geographic/weather data associated with a target object), partner data (e.g., data from a partner organization), behavior data (e.g., data associated with the past behavior of the object and/or user of the object), rules (e.g., rules from rules engine 306, and the like). The data processing engine 304 can process the received data to a form that can be used by the recommendation engine 302. In some implementations, the data processing engine can additionally process data and/or transform the data into a form that can be used by other users and services (e.g., supplier servers, data visualization software, data analytics, market research companies, software services such as customer support systems, marketing automation systems, customer relationship management systems, ecommerce systems, content management systems, inventory management, etc.). In some implementations, the data processing engine 306 can receive data from a data warehouse 602 that can store curated data associated with the object monitoring system.

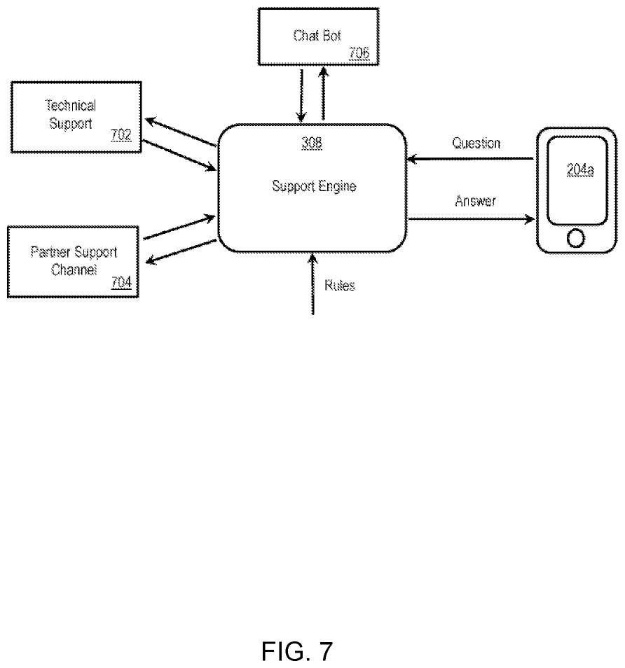

FIG. 7 illustrates an exemplary support engine 308. The support engine 308 can receive question/queries from a user of the application 204a (or 204b) executed in an operating device of the user of the object. For example, the user can ask questions related to the upkeep of the object (e.g., desirable temperature/humidity associated with the object, precautionary steps that need to be taken in view of an impending set of external conditions, and the like). The support engine 308 can communicate with technical support 702, partner support channel 704, and a chat hot 706 in order to generate a reply to the user question. In some implementations, the support engine can peruse through a predetermined list of question in a database and identify a match for the received question, and generate an answer based on the predetermined list of answers in the database. In some implementations, the support engine 308 can transmit the received question to a technical support 702 or a chat hot 706 and request an answer. In some implementations, the support engine 308 can receive data from a partner support channel 704 and can retrieve the answer from the received data. In some implementations, the support engine 308 can also receive rules (e.g., from PSME, rules engine 304, and the like) and can apply the rules on existing data to determine the answer to the user question. After the answer has been determined the support engine 308 can transmit the answer to the user.

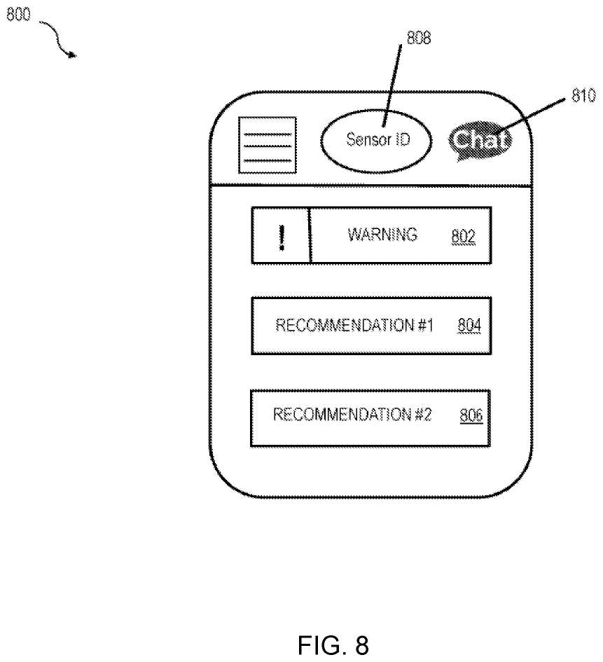

FIG. 8 illustrates an exemplary graphical user interface (GUI) display space 800 associated with the application (e.g., application 204a, 204b, and the like) executed on a user computing device. The GUI display space 800 can include a warning graphical object 802 and recommendation graphical objects 804 and 806.

The warning graphical object 802 can be displayed when the platform 300 transmits a warning signal to the application. For example, based on sensor data, the platform 300 can determine that the operating conditions of the object are undesirable, and can warn the user. In some implementations, the application can include a predetermined set of rules that can be executed by a processor associated with the application. Based on the predetermined set of rules, the application can determine whether the operating conditions (e.g., detected by sensors coupled to the object) are undesirable. Once undesirable operating parameter of the object has been determined, the warning graphical object 802 can be displayed.

The GUI display space 800 can include one or more recommendation graphical objects (e.g., graphical objects 804 and 806). The recommendation graphical objects can include recommendations provided to the application by the platform 300. In some implementations, the recommendation graphical objects can include a schedule for implementations of the recommendation (e.g., several time markers indicative of degree of damage to the artificial environment if the recommendation is not implemented). The GUI display space 800 can allow the end user to implement the received recommendation.

The GUI display space 800 can include the identity 806 of the sensor (or the target object) that is under observation by the application. Sensor ID information can be helpful if the application is associated with multiple sensors (or target objects).

The GUI display space 800 can include a query graphical object 810 that can allow the user to interact with the platform 300. For example, the user can transmit questions to the support engine 308 via the query graphical object 810. In some implementations, the end user (or an object associated with the end user) can be registered with the object monitoring system via the GUI display space 800. In some implementations, sensors (e.g., operatively coupled to target objects) can be registered with the object monitoring system via the GUI display space 800.

In view of the above systems, certain artificial environments can be monitored using the system as the target object. Some implementations of the current subject matter can include a system to monitor and maintain enclosures of exotic reptiles.

Artificial environments (e.g., enclosures of reptiles) may have desirable ultraviolet B (UVB) radiation, temperature, and/or humidity requirements. For example, it can be desirable to maintain a certain spatial temperature distribution in the artificial environment (“environment”) and/or maintain the environment humidity level in a predetermined range. Additionally or alternately, it can desirable to maintain a certain level of UVB radiation in the environment. This can be achieved, for example, by placing one or more sensors in the environment that can detect environment conditions (e.g., temperature, humidity, UVB radiation, etc.), and using the detected values to regulate the environment (e.g., by regulating the temperature of heat lamps, turning on/off a humidifier, replacing the UVB bulb, etc.). The regulation of various parameters of the environment can include monitoring and maintenance of multiple components (e.g., sensors, UVB lamps, heaters, humidifiers, etc.) of the environment. It can be desirable to improve the monitoring system of the environment to detect a current or future need for maintenance of the components in the environment (e.g., change of the UVB source, repair of the temperature or humidity control system, etc.), and generate an alert signal associated with the maintenance need.

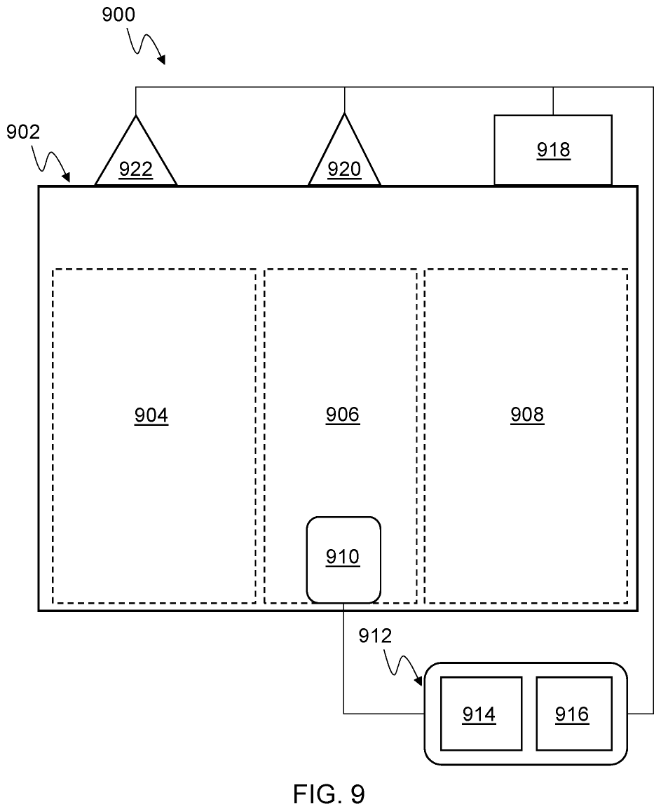

FIG. 9 illustrates an artificial environment monitoring system 900 which can be used to house a reptile within an enclosure 902. As stated above, reptiles can have very specific parameters which must be met within their artificial environment in order to survive. For example, if the temperature of the artificial environment 900 is too cold, the reptile may not be able to digest food properly. Additionally, if a UV light source is set to a higher than required level, the reptile can be burned by the UV light.

Existing enclosures of reptiles can include a heat source 922 with a raised heating area 904 (e.g., located under the heat source 922), and an ambient area 908 (e.g., having a shaded region) away from the heat source 922 (e.g., on the other side of the enclosure 902). In order to facilitate proper temperature monitoring of the enclosure 902, two thermometers (not shown) (e.g., one in each of the basking and the ambient areas) can be provided. The thermometers may need to be regularly (e.g., daily) monitored. Additionally, a central area 906 can be arranged within the enclosure between the heating area 904 and the ambient area 908. In some implementations, a UVB source 920 can also operate as a heat source, and the detection from the sensor 910 can be used to regulate both UVB radiation levels and temperature distribution of the enclosure 902.

UVB, temperature and humidity control can be used to provide desirable conditions in the artificial environment. UVB can be provided by one or more sources 920 (e.g., a bulb) that emit UVB at desirable intensities. Even though UVB is discussed within the example below, any type of UV light, such as UVA or UVC can be used and should be considered. The UVB source 920 can degrade over time resulting a reduction of the intensity of the emitted UVB. When the intensity of UVB radiation is less than a desirable value (e.g., a predetermined intensity), the source 920 may need to be replaced or may need maintenance. The temperature of the enclosure 902 can be controlled by a heating and/or cooling system 922. The humidity of the enclosure 902 can be maintained by an active or a passive humidity control system 918.

Maintenance operations can be performed based on manual measurements of conditions, and/or on periodic schedules based on historical norms or averages that have been observed to be appropriate and conservative. However, these schedules may not provide response to the actual conditions in the environment at any moment in time. In the example of a reptile enclosure 902, UVB intensity and/or humidity levels are measured using sensors in the monitoring system 900, and alerts are generated when the values are out of a specified range (e.g., a predetermined desirable range). The condition of the basking and ambient areas can be established through a calibration routine followed by standard monitoring. The monitoring of the enclosure 902 is performed by a moveable sensor 910, which is communicatively coupled to a control unit 912. In an exemplary embodiment, the sensor 910 can be battery powered and wirelessly connected to a control unit 912. The control unit 912 includes a processor 914 and a computer readable memory 916. Additionally, the control unit 912 is communicatively coupled to the humidity control unit 918, the UV light source 920, and the heat lamp 922 in order to send control signals to activate or deactivate the connected objects.

Temperature distribution in an enclosure 902 with a single heat source 922 can be consistent with and can be correlated to the temperature a central area 906 (e.g., located between the heating area 904 and the ambient area 908). For example, a routine may include the following steps: (1) place the sensor 910 in the heating area 904 for a predetermined time (e.g., 30 minutes) and record the average temperature; (2) place the sensor 910 in the ambient area 908 for predetermined time (e.g., 30 minutes) and record the average temperature; (3) place the sensor 910 in a central area 906 and record the average temperature of the central area 906. With the average temperatures recorded, the difference between the heating area 904 average temperature and the central area 906 average temperature is computed by the processor 914, and the difference between the ambient area 908 average temperature and the central area 906 average temperature is computed by the processor 914. For each new temperature measurement in the central area 906, 4) add/subtract the differences to the measurement to calculate the expected basking and ambient area temperatures.

In addition to standard monitoring and alerting based on various care conditions, remediation information or control of the monitoring system 900 can also be provided. For example, when a UVB bulb 920 starts to fail, a new bulb can be ordered on the owners behalf. When the humidity in the enclosed environment falls below a desirable value, an educational video on how to properly mist the reptile may be presented (e.g., on a user device) or the humidity control system 918 can be activated to bring the humidity within a threshold range of the enclosure 902. When the temperature falls below a predetermined value, the heating lamp 922 can be turned on or an alert can be sent to a user to activate the heat lamp 922.

In some implementations, the monitoring system can provide an improved measurement system capable of detecting environmental conditions automatically and at a frequency equivalent to continuous monitoring. Processing these measurements can provide the basis for generating alerts and recommendations of appropriate action for the maintenance of the enclosure. With an alert, a remediation can be automatically triggered such as releasing humidity into the artificial environment, or a remediation recommendation can include information to a user on suggested action(s) to take.

In some implementations, the sensor 910 can measure the UVB light output, temperature and humidity of the enclosure 902. One component of the monitoring system 900 is a sensor 910 communicatively coupled to the processor 914. The sensor 910 can routinely measure the UVB radiation created by an artificial UVB light source 920, and the processor 914 can identify (e.g., based on UVB measurement by the sensor 910) when the UV light source 920 begins to fail. Human eyes cannot see UVB, yet UVB bulbs often emit visible light as well which can give the impression that the bulb is functioning correctly. UVB bulbs tend to have a shorter life span (e.g., between 3 to 6 months of proper UVB radiation) compared to visible light bulbs that may last well over a year.

Combining the measurements detected by the sensor 910 in a near continuous monitoring system can provide for improved maintenance of desirable conditions in the enclosure 902. An example of combining measurement to determine a secondary property of the enclosure 902 can include day/night cycling. Using the detected temperature and UVB light level, a day/night cycle can be determined, which allows the monitoring system 900 to react appropriately based on the time of day. For example, if the monitoring system 900 has determined that it is currently nighttime, the system 900 can activate the heat source 922 if the enclosure is below a threshold level, since the system 900 knows that external temperature will not increase for an extended period of time.

For UVB sensitive applications, routine monitoring of UVB radiation to identify a failure before the occurrence of the failure can be critical. The monitoring system 900 can take corrective action (e.g., ordering service or a new bulb) in advance of a failure to optimize the environmental factors within the enclosure 902.

In one implementation, the objective of the monitoring system 900 can be to identify when the light source begins to fail. This can require repeated (e.g., periodic) measurements over a time duration. For example, if the expected failure mode is a linear decay after N number of days, a low pass filter can be applied to the derivative of the UVB signal intensity 1006, and can be used to identify the inflection point 1008.

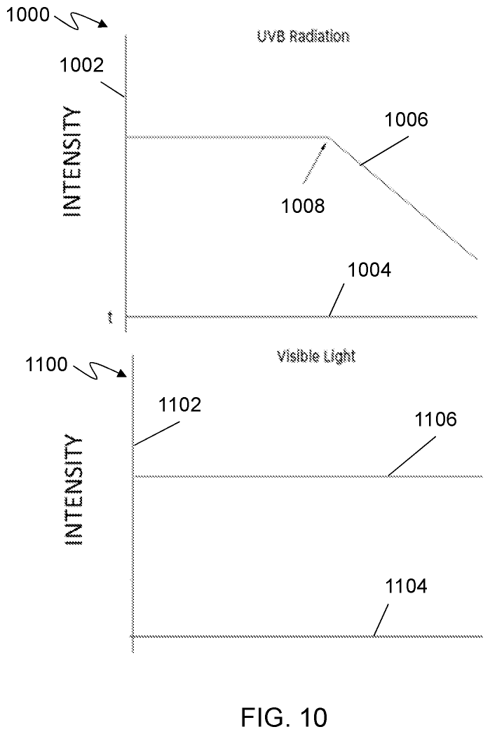

As illustrated in FIG. 10, a graph 1000 of the output of a UVB bulb is depicted. The axis 1002 represents the intensity of the UVB light level and the axis 1004 represents time. The line 1006 represents the actual UVB output of the UVB bulb. As shown in the graph 1000, the intensity of the UVB light can begin to decline after a certain time period at point 1008, while the intensity of visible light from the same bulb remains unchanged (or very little change). As illustrated in graph 1100, the axis 1102 represents the intensity of the visible light level output from the UVB light source, and the axis 1104 represents time. The line 1106 represents the actual visible light output of the UVB bulb over time. As shown in the graph 1100, the intensity of the visible light 1106 does not decrease even though the intensity of the UVB light 1006 is decreasing.

In an exemplary implementation, the sensors, processing, and alerting functions of the monitoring system 900 can either be self-contained in a single unit or decoupled. A self-contained unit can include a sensor probe in the enclosure 902 connected to a processor 914 that sounds an alarm when an alert condition is reached. Alternatively, a decoupled unit can include sensors in the enclosure 902 with a wireless radio, which can send the measurements to a remote server or control unit 912 which processes the data identifying alerts and warning states, which can then be sent to a mobile phone for display to a user. In either the case of a self-contained unit or a decoupled sensing unit, the alert system may be connected to a maintenance system that has the capability to take remediation actions without user intervention. For example, the maintenance system can automatically activate/deactivate the humidity control system 918, the UV light source 920, and/or the heat source 922.

Example Pet: Bearded Dragon

Bearded dragons can make a great pet reptile. They do not get too large, eat a wide variety of foods, are active during the day, and are gentle. These friendly animals can be captive-bred, have limited care requirements, are readily available, and inexpensive. A bearded dragon can be a great addition to one's family. Bearded dragons can recognize and respond to their owners' voices and touch and are usually even-tempered. They can be great pets for someone who wants a reptile who likes to be held and taken out of his cage. They are generally easy to handle. For example, the owner can support their wide, flat bodies from underneath and allow them to walk from hand to hand as they move. Dragons can even be handled by children as long as the children are supervised by adults. Anyone who handles a dragon must wash up afterward.

Bearded dragons are lizards that are native to Australia. They live in rocky and arid regions of the country and are adept climbers. In the wild, they can be found on branches, basking on rocks, and staying cool in bushes and other shaded areas. Bearded dragons have large triangular heads and flat bodies with pointed ridges along the sides. Their scales are spiny and appear dangerous but are soft, flexible, and not very sharp. They are omnivorous, eating both insects and plants. These reptiles grow to be 16 to 24 inches long.

In order to take good care of a bearded dragon, the owner may want to make sure it receives proper care. For example, the owner may want to have everything needed to take care of the bearded dragon before it is bought. Recommendations from the object monitoring system 900 can provide the owner with the list of desirable bearded dragon care items.

The recommendation can include getting a large cage/enclosure 902 (e.g., a large aquarium or terrarium with a screened top) because the animal can fully grow to about 24 inches. The recommendations can include a combination light fixture that supports fluorescent and incandescent lights 920, 922 (e.g., UVB fluorescent bulb daylight bulb or heat emitter, and the like). The recommendations can include substrate for the bottom of the tank, hiding area for the bearded dragon, rocks, branches, or logs for climbing and basking. The recommendations can include food bowl, smooth insect bowl, and a water dish. The recommendations can include any additional decorations, backgrounds, or artificial plants to make the habitat look more natural.

The recommendations can include lighting and heating equipment. For example, fluorescent bulbs are the most widely used bulbs on the market today. These bulbs are relatively inexpensive, energy-efficient, and provide the proper wavelengths of UV rays to accommodate bearded dragons. Not just any fluorescent bulb may suffice. For example, the owner may need to use fluorescent bulbs that are specifically designed and manufactured for reptiles. Regular household fluorescent tubes may not have the UV output needed to benefit a captive-raised reptile.

Supplying adequate UV radiation during the day can help ensure that bearded dragons can make vitamin D in their skin, which can allow them to absorb both calcium and phosphorus from their food. This can be essential for proper bone formation, muscle contraction and many of the body's normal metabolic processes. Without adequate UV light, dragons will draw calcium out of their bones, which then become soft and fracture easily. They can also have muscle tremors from poor muscle contraction, their organs will fail and, ultimately, they can die. The temperature in their tanks needs to range from 100 degrees Fahrenheit on one end, where they can bask in the UV light, to 70 degrees Fahrenheit on the other end, where they can cool off if they choose. Having the appropriate temperature gradient in the tank is essential to their health. Reptiles' body temperature can adjust to that of their environments, and the function of their immune systems, digestion and metabolism can be temperature dependent.

The fluorescent bulbs usually need to be placed within twelve inches of the bearded dragon so that it receives sufficient radiation. The fluorescent bulbs can become weaker over time and may requiring frequent replacement. The general rule of thumb is to replace fluorescent tubes every 6 months. UV light cannot penetrate glass, so when overhead UVB light sources 920 are used, the top of the enclosure must be a wire mesh that is not too fine. The recommendations can indicate that the UVB light source 920 should be less than 18 inches from where the Bearded Dragon spends most of its time (e.g., 10-12 inches may be optimal).

The recommendation can include suggestions for food and diet of the bearded dragon. Bearded dragons are omnivorous, and can eat both insects and vegetables. Adult dragons will also eat pinky mice, baby lizards, and the like. They tend to do best on a varied diet based primarily of vegetables. Bearded dragons can eat vegetables prepared in a desirable manner. For example, greens may need to be chopped up. The smaller the reptile the more finely chopped the greens need to be. A good mix of vegetables for these lizards can include raw shredded carrots, collard greens, dandelion greens, mustard greens, kale, and frozen vegetables like carrots, peas, and beans.

Recommendation for food of the bearded dragon can include common insects available for reptiles (e.g., crickets, mealworms, super worms, wax worms, and the like). Bearded dragons may usually eat ah types of insects and insects should be a part of diet every other day. The insects may be gut loaded before feeding them to the pet dragon. Gut loading can include feeding the insects a nutritious meal before giving them to the bearded dragon. This way, the insects can pass along the nutrients to the bearded dragons. There are many commercially available cricket and insect diets for gut loading.

The recommendations can include dietary supplements. For example, the bearded dragon may need a calcium and vitamin D3 supplement. If the bearded dragon is lacking D3 and calcium it can get metabolic bone disease which can be fatal. The supplement may come in a powder form which the owner can sprinkle on the vegetables or coat the insects. Insects can be coated by placing and shaking them in a bag or a cup. The owner can add the supplement to the adult dragons diet about once a week. Breeding females, babies, and juveniles may need supplements more often.

The recommendations can include suggestions on cages and supplies. For example, bearded dragon may need spacious housing. For example, the housing should be larger than 36″×12″×18″ for one dragon. Bigger housing can be better especially when there are multiple bearded dragons. Height of the housing may be important because bearded dragons like to climb and sit on top of logs and branches. An aquarium or a terrarium fit-ted with a screened top can make a nice home for your pet.

The bearded dragon may need food bowl, smooth insect bowl (for mealworms, and the like), and water dish. Bearded dragons may need a hide area like a cave or a log. There may be many natural-looking commercial shelters available. Sturdy branches, logs or rock formations may be needed to keep the bearded dragon happy because bearded dragons like to climb and bask at high perches. The owner may have to make sure that the climbing areas are secure and the bearded dragons will not fall and get hurt. The owner can add artificial plants and decorations to his home to create a more scenic habitat.

The recommendations can include suggestions on landscaping and furniture for the bearded dragon. Branches for climbing and basking under the secondary heat source should be secure. These branches should be of various sizes and not ooze pitch or have a sticky sap (e.g., oak can works very well). The branches should be as wide as the width of the Bearded Dragon. Boards covered with indoor/outdoor carpet also make good climbing posts. Flat-bottomed, smooth rocks are a good addition to the habitat, and can help wear down the toe-nails, which in captivity, must be clipped often. Reptiles like a place where they can hide. This could be an empty cardboard box, cardboard tube, or flower pot. The hiding place should provide a snug fit and should be high in the enclosure. If the bearded dragon does not use its hiding place, a different hiding place may be tried or the dragon can be move to a different location. Appropriate plants (e.g., non-toxic) in the enclosure can provide humidity, shade, and a sense of security. They also add an aesthetic quality to the enclosure. Dracaena, Ficus benjamina, and hibiscus are good choices. It can be desirable that the plants have not been treated with pesticides and the potting soil does not contain vermiculite, pesticides, fertilizer, or wetting agents. Washing the plants with a water spray and watering it thoroughly several times to the point where water runs out of the bottom of the pot can help remove toxic chemicals, which may have been used. Keeping purchased plants in a different part of the house for a while before putting them in the enclosure can also be helpful.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof.

These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term, “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term, “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as, “at least one of” or “one or more of” may occur followed by a conjunctive list of elements or features. The term, “and/or” may also occur in a list of two or more elements or features.

Unless otherwise implicitly or explicitly contradicted by the context in which it is used, such a phrase is intended to mean any of the listed elements or features individually or any of the recited elements or features in combination with any of the other recited elements or features. For example, the phrases, “at least one of A and B;” “one or more of A and B;” and “A and/or B” are each intended to mean, “A alone, B alone, or A and B together.” A similar interpretation is also intended for lists including three or more items. For example, the phrases, “at least one of A, B, and C;” “one or more of A, B, and C;” and “A, B, and/or C” are each intended to mean, “A alone, B alone, C alone, A and B together, A and C together, B and C together, or A and B and C together.” In addition, use of the term, “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method, comprising:
receiving data characterizing first parameter measurements recorded by a sensor in a heating area of an enclosure for a first duration of time, second parameter measurements recorded by the sensor in an ambient area of the enclosure for a second duration of time, and third parameter measurements recorded by the sensor in a central area, located between the heating area and the ambient area, for a third duration of time;
determining a first average parameter recorded during the first duration of time, a second average parameter recorded during the second duration of time, and a third average parameter recorded during the third duration of time;
computing a first parameter difference between the first average parameter in the heating area and the third average parameter in the central area, and a second parameter difference between second average parameter in the ambient area and the third average parameter of the central area; and
providing the first parameter difference and the second parameter difference.

2. The method of claim 1, wherein the first parameter measurements, the second parameter measurements, and the third parameter measurements are temperature measurements.

3. The method of claim 1, further comprising:
receiving data characterizing fourth parameter measurements recorded by the sensor in the central area for a fourth duration of time;
determining a fourth average parameter recorded during the fourth duration of time;
computing a calculated heating area parameter and a calculated ambient area temperature based on the first parameter difference, the second parameter difference and the fourth average parameter; and
providing the calculated heating area parameter and the calculated ambient area parameter.

4. The method of claim 3, wherein the fourth parameter measurements are UV light level measurements.

5. The method of claim 3, further comprising computing, a day and/or night cycle based on the fourth average temperature.

6. The method of claim 3, wherein the fourth measurements include a humidity level.

7. The method of claim 1, further comprising receiving data characterizing UV light level measurements recorded by the sensor in the central area.

8. The method of claim 7, further comprising computing a day and/or night cycle based on the recorded UV light level measurements.

9. The method of claim 8, wherein the UV light level measurements are type B ultraviolet light level measurements.

10. A method comprising:
receiving, by a server, a temperature data set, a humidity data set, and an ultraviolet light level data set, characterizing measurements of a plurality of characteristic properties of an artificial environment by a sensor operatively arranged within the artificial environment, wherein an artificial environment monitoring system includes the server and the sensor;
determining, by a predictive model, a first rule characterizing environmental requirements of an object in the artificial environment;
generating an output data set based on the received data sets and the first rule; and
transmitting the generated output data set.

11. The method of claim 10, wherein the first rule is based on information associated with the artificial environment provided by the user, previous measurements of the characteristic properties by the sensor, and the received data sets.

12. The method of claim 10, wherein the output data set includes information and/or instructions associated with care of the artificial environment.

13. The method of claim 10, wherein the output data set includes an object replenishment recommendation associated with a consumable object within the artificial environment.

14. The method of claim 10, wherein the output data set includes a control command associated with stabilization of the artificial environment.

15. The method of claim 14, wherein control command is associated with the control at least one of:
a heating source;
a humidifier; or
a UV source.

16. The method of claim 10, wherein generating the output data set for the artificial environment is further based on one or more of environmental data associated with the artificial environment, usage of the artificial environment, location of the artificial environment, and a type associated with the artificial environment.

17. The method of claim 10, wherein the artificial environment monitoring system further includes an application on a computing device associated with the user of the artificial environment, and the receiving of the data sets by the server is via the application.

18. The method of claim 17, wherein the generated output data set is transmitted to the computing device.

19. A system comprising:
at least one data processor;
memory storing instructions which, when executed by the at least one data processor, causes the at least one data processor to perform operations comprising:
receiving, by a server, a temperature data set, a humidity data set, and an ultraviolet light level data set, characterizing measurements of a plurality of characteristic properties of an artificial environment by a sensor operatively arranged within the artificial environment, wherein an artificial environment monitoring system includes the server and the sensor;
determining, by a predictive model, a first rule characterizing environmental requirements of an object in the artificial environment;
generating an output data set based on the received data sets and the first rule; and
transmitting the generated output data set.

20. The system of claim 19, wherein the output data set includes at least one of:
information and/or instructions associated with care of the artificial environment;
an object replenishment recommendation associated with a consumable object within the artificial environment; or
a control command associated with stabilization of the artificial environment.
